(19) United States
(12) Patent Application Publication
(10) Pub. No.: US 2025/0335800 A1
(43) Pub. Date: Oct. 30, 2025

(54) PROBABILISTIC BLACK-BOX ANOMALY ATTRIBUTION

(71) Applicant: International Business Machines Corporation, Armonk, NY (US)

(72) Inventors: Tsuyoshi Ide, Harrison, NY (US); Naoki Abe, Rye, NY (US)

(73) Assignee: International Business Machines Corporation, Armonk, NY (US)

(21) Appl. No.: 18/229,407

(22) Filed: Aug. 2, 2023

(51) Int. Cl. G06N 7/01

(52) U.S. Cl. CPC G06N 7/01

(57) ABSTRACT

An embodiment identifies, by a probabilistic black-box anomaly attribution engine, an anomalous sample in test data associated with a black-box model, the black-box model comprising a plurality of variables. The embodiment generates, by the probabilistic black-box anomaly attribution engine, a variable distribution based on the test data using a plurality of outputs generated using a plurality of perturbations. The embodiment generates, by the probabilistic black-box anomaly attribution engine based on the variable distribution, an attribution score representing a responsibility of a variable for the anomalous sample.

### BACKGROUND

The present invention relates generally to black-box machine learning prediction models. More particularly, the present invention relates to a method, system, and computer program for probabilistic black-box anomaly attribution using a novel framework called “generative perturbation analysis,” as explained herein.

In recent times, machine learning models have seen a resurgence, with many applications in real-world scenarios. However, the opacity of these machine learning algorithms has raised concerns, leading to increased interest in explainable artificial intelligence (XAI) in the data mining domain. Initially focused on the psychological aspects of artificial intelligence's explainability, the emphasis of XAI research is now on its practical application in business and industry. A pressing question in this realm is how to identify the influence of each input when there is a noticeable difference between a model's prediction and the observed event, or “anomaly attribution.”

### SUMMARY

The illustrative embodiments provide for probabilistic black-box anomaly attribution.

An embodiment includes identifying, by a probabilistic black-box anomaly attribution engine, an anomalous sample in test data associated with a black-box model, the black-box model having a plurality of variables. Anomalous samples may be used to identify the attribution of the black-box model's variables to the anomalous sample. This can be beneficial, for example, in real estate where anomalies could point to factors like unexpectedly high or low property prices which can be further investigated.

The embodiment also includes generating, by the probabilistic black-box anomaly attribution engine, a variable distribution based on the test data using a plurality of outputs generated using a plurality of perturbations. The use of multiple perturbations to create a variable distribution may help ensure a comprehensive understanding of the black-box model's behavior under varying conditions. In a real estate context, for example, this could help in understanding the sensitivity of property values to different factors, such as the number of rooms or age of the property.

The embodiment also includes generating, by the probabilistic black-box anomaly attribution engine, an attribution score representing a responsibility of a variable for the anomalous sample. The generation of an attribution score provides a quantifiable metric to determine the significance of different variables. In real estate, for example, such a score can identify which factors (like size, location, or nearby schools) have the most considerable influence on an anomalous property price. By understanding the weight of each variable, analysts can make more informed decisions or recommendations.

The described embodiment offers a robust methodology for understanding and interpreting black-box models. The system provides a holistic view of the factors influencing the outputs of the model.

An embodiment includes performing expected value estimation for each variable in the plurality of variables by using an estimated local gradient and a sparsity constraint. Utilizing both the estimated local gradient and a sparsity constraint offers a fine-tuned approach to expected value estimation, ensuring a balance between model accuracy and complexity. Within the realm of real estate, for example, this could ensure that property valuations consider important factors (local gradient) while avoiding overfitting due to insignificant variables (sparsity constraint).

In an embodiment, identifying the anomalous sample further includes generating a plurality of anomaly scores by computing a negative natural logarithm of a conditional probability using the test data; and identifying the anomalous sample by applying an anomaly threshold to the plurality of anomaly scores. A technical advantage of generating a plurality of anomaly scores by computing a negative natural logarithm of a conditional probability using the test data is that it offers an efficient mathematical approach to anomaly detection. Utilizing the negative natural logarithm transforms the probability values in a way that makes anomalies more distinguishable, especially when probabilities are very small. This transformation amplifies the distinctions between normal and anomalous data points, leading to more accurate detection.

In an embodiment, generating the variable distribution further includes determining a variable-wise posterior distribution by performing statistical parameter fitting, the statistical parameter fitting being based on the plurality of outputs generated using the plurality of perturbations. This approach may help ensure that the variable distribution accurately reflects the data by considering a multitude of scenarios (perturbations).

An embodiment includes utilizing a variational Bayesian inference to determine the variable-wise posterior distribution. Variational Bayesian inference offers an efficient way to approximate complex probability distributions, ensuring faster and more scalable model evaluations.

In an embodiment, generating the variable distribution further includes computing a plurality of maximum a posteriori (MAP) points for the plurality of variables; and performing the statistical parameter fitting by estimating the plurality of variables at their MAP points and by varying the plurality of perturbations. By focusing on MAP points, the embodiment may zero in on the most likely values for each variable, optimizing the model's accuracy.

In an embodiment, generating the attribution score further includes assigning a high attribution score for a sharp variable distribution; and assigning a low attribution score for a flat variable distribution. This distinction allows for an intuitive understanding of how each variable affects the model output. Users could easily identify which property features (e.g., location or size) have a significant impact on the price.

An embodiment may perform expected value estimation for each variable using an estimated local gradient and a sparsity constraint, and simultaneously identifies the anomalous sample by applying an anomaly threshold to the plurality of anomaly scores generated from test data. In a real estate context, for example, this embodiment may help ensure that the expected value for each property feature is calculated with precision while also identifying properties that do not fit the usual data patterns. Using an estimated local gradient offers a meticulous approach to value estimation, ensuring that the nuances of each property feature are captured. The sparsity constraint helps to eliminate the influence of insignificant variables, leading to a more streamlined and focused model. The anomaly threshold applied to the anomaly scores efficiently weeds out outlier properties, ensuring that the model is not skewed by unusual data.

An embodiment utilizes a variational Bayesian inference to determine the variable-wise posterior distribution and then computes a plurality of MAP points for these variables, performing statistical parameter fitting by estimating the variables at their MAP points and varying the perturbations. In the context of real estate, for example, this embodiment offers a thorough and statistically rigorous approach to understanding the importance and interaction of different property features in determining property value. Variational Bayesian inference provides an effective means of approximating complex distributions, ensuring quicker property evaluations. Using MAP points focuses on the most probable values for each variable, offering a clearer understanding of each variable's contribution to the model.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment.

FIG. 2 depicts a block diagram of an example software integration process in accordance with an illustrative embodiment.

FIG. 3 depicts a block diagram of an example environment for probabilistic black-box anomaly attribution in accordance with an illustrative embodiment.

FIG. 4 depicts a block diagram of an example test data in accordance with an illustrative embodiment.

FIG. 5 depicts a block diagram of an example informative variable and an example non-informative variable in accordance with an illustrative embodiment.

FIG. 6 depicts a block diagram of an example process for probabilistic black-box anomaly attribution in accordance with an illustrative embodiment.

FIG. 7 depicts a block diagram of an example process for performing expected value estimation in accordance with an illustrative embodiment.

FIG. 8 depicts a block diagram of an example process for performing distribution estimation in accordance with an illustrative embodiment.

FIG. 9 depicts a block diagram of an example process for probabilistic black-box anomaly attribution in accordance with an illustrative embodiment.

### DETAILED DESCRIPTION

In recent times, the resurgence of machine learning models has led to substantial advancements in numerous real-world applications. However, as these technologies have proliferated, so too have concerns about their transparency. This has catalyzed the push for explainable artificial intelligence (XAI) within the data mining realm. Early stages of XAI research were primarily centered around the psychological aspects of making artificial intelligence comprehensible. As artificial intelligence's integration into various sectors increased, the focus of research has transitioned towards actionable applications in business and industrial contexts. One significant challenge arising in this environment is pinpointing the influence of each input when a machine learning model's prediction deviates noticeably from an observed event. Several model-agnostic post-hoc XAI methods, such as Local Interpretable Model-agnostic Explanations (LIME), Shapley value, and integrated gradient, have been commonly used to tackle this challenge.

However, these existing methods face several drawbacks. For example, they tend to explain the black-box model itself in the form of the local gradient or an increment, rather than the observed deviation. Moreover, there is a glaring limitation in these techniques' ability to quantify the uncertainty of attribution scores. Quantifying uncertainty is emerging as a crucial topic in XAI research, especially for industrial applications. In scenarios where researchers work with a black-box model without access to its training data, addressing this problem becomes particularly daunting, with very few research efforts having tackled it comprehensively to date.

The present disclosure addresses the deficiencies described above by providing a process (as well as a system, method, machine-readable medium, etc.) that introduces a novel probabilistic framework, called generative perturbation analysis, for anomaly attribution in black-box regression settings. This framework may involve considering a counterfactual data generative process with perturbation included as a model parameter, and reducing the task of attribution to that of statistical parameter estimation. In doing so, the uncertainty in attribution may be naturally evaluated by determining its posterior distribution. The framework may also include using approximations through statistical models (e.g., by using variational Bayes inference) to break down the contribution of each variable.

Illustrative embodiments provide for probabilistic black-box anomaly attribution. “Probabilistic black-box anomaly attribution,” as used herein, may refer to a process of determining the likelihood or probability that specific input features or components are responsible for unexpected or anomalous outcomes from a black-box model. That is, given a black-box regression model and observed test sample(s), this process may compute the distribution of the score for each variable indicative of the extent to which that variable is responsible for the sample being anomalous. Its probabilistic aspect denotes the use of statistical methods to assign probabilities or uncertainties to conclusions made about the influence of different input features on the anomaly. Anomaly attribution may involve identifying and attributing the causes or sources of anomalies. In the context of machine learning, this may involve understanding which variables of the model led to a prediction that resulted in the anomaly.

A “black-box model,” as used herein, may refer to a type of model whose internal workings or logic are not readily apparent or decipherable. The model may take inputs and produce outputs, but the user may not have direct knowledge of the underlying rules, equations, or algorithms that dictate how the input is transformed into the output. For instance, machine learning models like deep neural networks, gradient boosting trees, and random forests can be treated as black-box models. Their black-box aspect might make it difficult for users to discern the exact process through which inputs are transformed into outputs. The black-box model may comprise a plurality of variables. A “variable,” as used herein, may refer to a characteristic, feature, or attribute that the model considers when making predictions. Variables can represent a wide range of data, from numerical measurements to categorical data, and each variable can have an impact on the model's output.

Illustrative embodiments may include identifying an anomalous sample in test data associated with a black-box model. “Test data,” as used herein, may refer to a set of data that the model has not been trained on and is used to assess the performance of the model. An “anomalous sample,” as used herein, may refer to a test sample that, upon evaluation, receives a high anomaly score indicating a significant discrepancy when compared to expected results from the black-box model. This high score quantifies the degree to which the sample is anomalous or deviates from the expected behavior of the model. These anomalies can indicate outliers, errors, or novel situations not previously encountered during the model's training. Identifying anomalous samples may include any suitable process, such as by computing the negative log-likelihood of the test sample as the anomaly score. From the deterministic regression model, for example, a probability density p(y|x) over y may be derived based on the given input x.

In some embodiments, identifying the anomalous sample may involve generating a plurality of anomaly scores by computing a negative natural logarithm of a conditional probability using the test data. This process may involve applying a negative logarithmic transformation to the probabilities generated by the model, which can help identify data points that the model is particularly uncertain about. Additionally, in some embodiments, identifying the anomalous sample may involve applying an anomaly threshold to the plurality of anomaly scores. This threshold can be determined based on domain knowledge or through empirical analysis, and any scores exceeding this threshold may be flagged as anomalous.

Illustrative embodiments may include generating a variable distribution. A “variable distribution,” as used herein, may refer to a statistical representation of the range and frequency of a particular variable's values across the data set. Generating a variable distribution may involve collecting the values of a variable across various data points, and then applying statistical methods to summarize these values in terms of their central tendency, dispersion, or overall pattern. For example, a variable distribution may be generated using a plurality of outputs generated using a plurality of perturbations. An “output,” as used herein, may refer to the predicted result that the model generates when given a specific set of inputs. A “perturbation,” as used herein, may refer to an intentional alteration made to an input to observe how it affects the model's output. This could involve a relatively small or a relatively large change to an input's value. This process can provide insights into how sensitive the model is to changes in each variable.

In some embodiments, generating the variable probability distribution may involve determining a variable-wise posterior distribution. A “variable-wise posterior distribution,” as used herein, may refer to a distribution of the expected values of a particular variable, given the observed data. Determining a variable-wise posterior distribution may involve applying Bayesian inference methods, which combine prior knowledge about the variable's distribution with the observed data to produce a refined, updated distribution. In some embodiments, determining a variable-wise posterior distribution may involve performing statistical parameter fitting. A “statistical parameter fitting,” as used herein, may refer to the process of adjusting the parameters of a statistical model to best match the observed data. Performing statistical parameter fitting may involve using techniques such as maximum likelihood estimation or least squares optimization to adjust the model parameters in a way that minimizes the difference between the model's predictions and the observed data. For instance, the statistical parameter fitting may be based on the plurality of outputs generated using the plurality of perturbations. This process may involve fitting the model parameters in a way that best captures the variations observed in the model's outputs when the inputs are perturbed. In some embodiments, determining a variable-wise posterior distribution may involve utilizing a variational Bayesian inference. Performing a variational Bayesian inference may involve using optimization techniques to approximate the posterior distribution, which can be useful when the exact posterior is computationally infeasible to compute.

Illustrative embodiments may include performing expected value estimation for each variable in the plurality of variables. “Expected value estimation,” as used herein, may refer to a calculation that determines the most likely value of a variable based on its probability distribution. In some embodiments, performing expected value estimation may involve using an estimated local gradient and a sparsity constraint. The local gradient can give an indication of how the expected value changes with small perturbations in the variables, and the sparsity constraint can encourage the solution to have as few non-zero components as possible. A “local gradient,” as used herein, may refer to the derivative of the model's output with respect to each variable, evaluated at a particular point in the input space. Estimating a local gradient may involve applying small perturbations to the variables and observing the resulting changes in the model's output. A “sparsity constraint,” as used herein, may refer to a constraint that encourages the model to use as few variables as possible to make its predictions. This can help prevent overfitting and improve interpretability. Applying a sparsity constraint may involve including a penalty term in the model's objective function that increases as the number of non-zero components in the solution increases.

In some embodiments, generating the variable distribution may involve computing a plurality of maximum a posteriori (MAP) points for the plurality of variables. “Maximum a posteriori, as used herein,” may refer to the mode of the posterior distribution, which represents the most probable value of the variable given the observed data. Computing a plurality of MAP points for the plurality of variables may involve optimizing the posterior distribution for each variable,.

Illustrative embodiments may include generating an attribution score. This score may quantify the impact or significance of a particular variable on the model's prediction. An “attribution” score, as used herein, may refer to a numerical measure that represents the degree to which a specific variable influenced the model's output. In some embodiments, an attribution score may represent a responsibility of a variable for the anomalous sample. This score may help in identifying which variables played a role in causing the anomaly. Generating an attribution score may involve analyzing the changes in the model's output as each variable is perturbed, and then identifying the variable(s) most responsible for the anomaly.

In some embodiments, generating an attribution score may be based on the variable distribution. Variables with a particular distribution may be deemed to have a greater or lesser impact on the model's output and thus receive a higher or lower attribution score. For example, generating the attribution score may involve assigning a high attribution score for a sharp variable distribution and a low attribution score for a flat variable distribution. A sharp variable distribution may represent a variable that has a more concentrated range of values and is thus more influential in the model's predictions. A flat variable distribution may represent a variable that has a wider range of values and is thus less influential in the model's predictions.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The process software for generative perturbation analysis is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

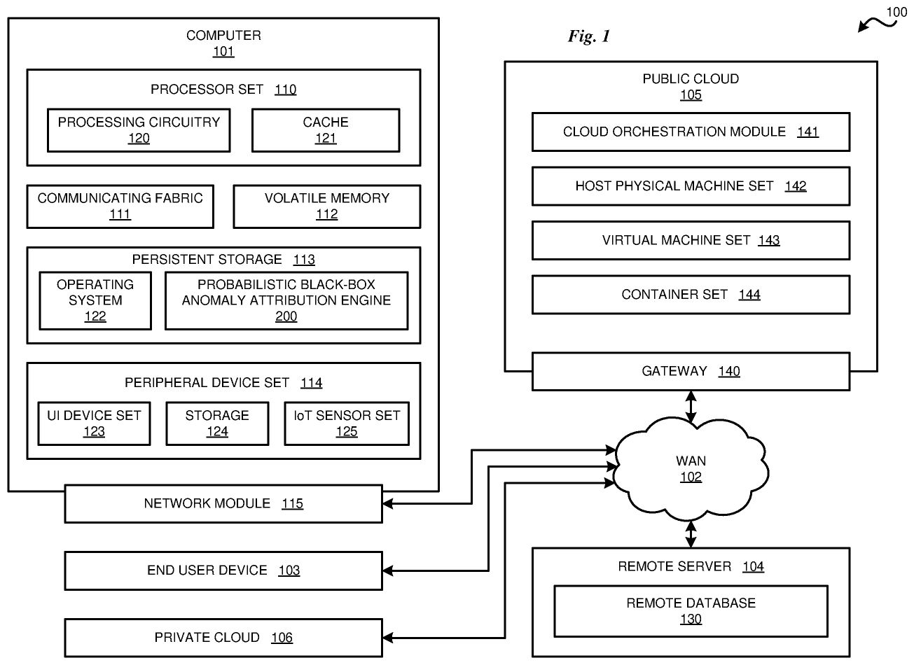

With reference to FIG. 1, this figure depicts a block diagram of a computing environment 100. Computing environment 100 contains an example of an environment for the execution of at least some of the computer code involved in performing the inventive methods, such as probabilistic black-box anomaly attribution engine 200 for probabilistic black-box anomaly attribution. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

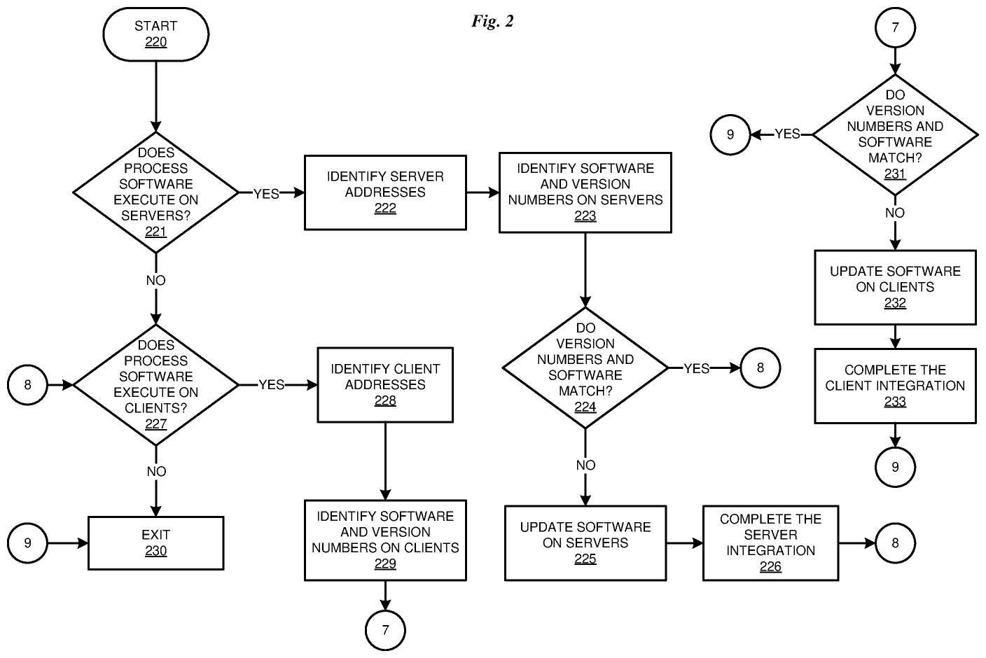

With reference to FIG. 2, this figure depicts a block diagram of an example software integration process, which various illustrative embodiments may implement. Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

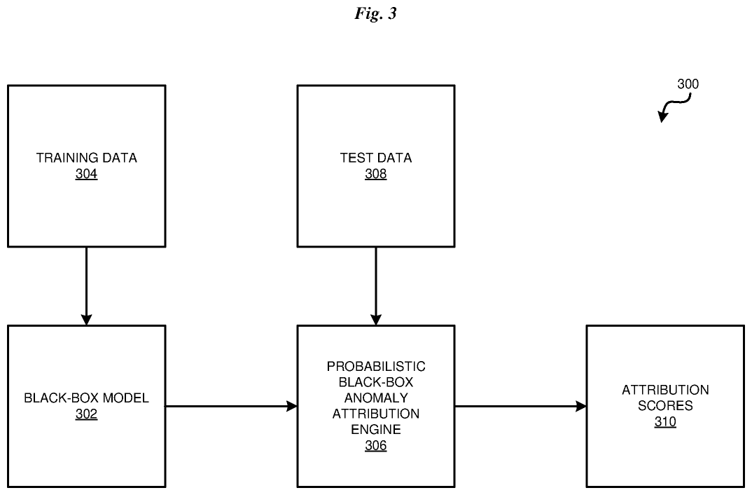

With reference to FIG. 3, this figure depicts a block diagram of an example environment for probabilistic black-box anomaly attribution 300. In the depicted example, the environment may include a black-box model 302, training data 304, probabilistic black-box anomaly attribution engine 306, test data 308, and attribution scores 310.

Black-box model 302 may represent a deterministic regression model where variables are transformed into a predicted output. In a black-box environment, neither the data that was used to train the model nor the underlying distribution of input data may be available, a situation often found when dealing with real-world data where original training data may be restricted due to confidentiality or operational reasons. However, the model may operate under the premise that variables are real-valued and potentially contain noise, and that the number of such variables is a fixed number. Further, the model may operate as a readily accessible algorithm that can provide outputs corresponding to any given inputs. For instance, in a house pricing scenario, the black-box model could be an algorithm predicting house prices based on variables such as the size of the house, the location, the age of the property, the number of rooms, and other relevant factors.

Training data 304 may represent data used to train the black-box model 302. This training data may be inaccessible in a black-box setting. For example, in a healthcare application, the training data could include sensitive patient information. Even when this information is not accessible (e.g., due to privacy or confidentiality concerns), it may be desirable to understand the black-box model's predictions for identifying and diagnosing anomalies. As shown, the training data 304 may be fed to the black-box model 302 in order for the model to develop its ability to predict outcomes based on the set of variables. In a real estate market analysis, for instance, the model may be trained on past house sales data. The model may then produce outputs based on new, unseen house feature data to predict potential house prices.

Probabilistic black-box anomaly attribution engine 306 may represent a system that detects and analyzes anomalies in the black-box model 302. It may employ one or more algorithms to spot irregularities in the input data and comprehend their implications on the black-box model, as explained herein. The probabilistic black-box anomaly attribution engine may serve to interpret the model's outputs by studying these anomalous perturbations, providing an understanding to the black-box model's operations. For instance, in a house pricing model, it could detect an unusual feature such as a house with a high number of rooms for its price range and evaluate how this anomaly impacts the model's prediction. The probabilistic black-box anomaly attribution engine may be configured to utilize a probabilistic attribution approach through a data-generating process of observed data. In one embodiment, for instance, it may utilize a generative process for observable variables as a parametric model of perturbation. In this manner, the task of anomaly attribution may be reduced to a parameter estimation problem, given an observed test point.

This approach may be understood using the following formulas, which the probabilistic black-box anomaly attribution engine may use to estimate perturbation δ for an observed anomaly. The actual observed value y^{t} may be close to what the model predicts at the perturbed input x^{t}+δ. The following equation presents a model for the conditional probability of observing an output y^{t} given an input x^{t}, a perturbation δ, and a precision parameter λ. The equation represents a Gaussian (normal) distribution centered around the value f(x^{t}+δ). Here, f is the black-box regression function, x^{t} is the input test point, and δ represents the deviation from the normal or “expected” input. λ plays the role of the precision of this distribution, which relates to the inverse of the variance. In this context, λ can be thought of as representing potential noise contamination.

$$p ( {y}^{{}_{t}} \vert {x}^{{}_{t}} , δ , λ ) = {( \frac{λ}{2 π} )}^{\frac{1}{2}} exp \{ - \frac{{λ [ {y}^{{}_{t}} - f ( {x}^{t} + δ ) ]}^{2}}{2} \}$$

This following equation defines the prior distribution of δ as a Gaussian distribution. It suggests that under normal circumstances (without anomalies), the expected perturbation δ from the regression model is zero. η is a hyperparameter that indicates the variance of this Gaussian distribution, and I_{M} is the identity matrix of size M, where M is the dimensionality of the input.

$$p ( δ ) = ( δ \vert 0 , {η}^{- 1} {I}_{M} ) {=}^{Δ} {( 2 π )}^{- \frac{M}{2}} {η}^{- \frac{1}{2}} exp \{ - \frac{η}{2} {‖ δ ‖}_{2}^{2} \}$$

The following equation gives the prior distribution of the precision parameter λ as a gamma distribution. This allows λ to be a random variable itself, thereby giving flexibility in modeling the precision (or variability) of the data. a₀ and b₀ are hyperparameters of the gamma distribution.

$$p ( λ ) = Gam ( λ \vert {a}_{0} , {b}_{0} ) {=}^{Δ} \frac{{b}_{0}^{{a}_{0}}}{Γ ( {a}_{0} )} {λ}^{{a}_{0} - 1} exp ( - {b}_{0} λ )$$

Test data 308 may include one or more samples. This data could represent various real-world data points used to assess the model's performance. For instance, in a house pricing model, test data might include a variety of house listings that are inputted into the model to test its ability to accurately predict prices based on the given features. Probabilistic black-box anomaly attribution engine 306 may utilize black-box model 302 and the test data 308 to determine an attribution score for each of the model's variables. The test data may include one or more anomalous samples, which probabilistic black-box anomaly attribution engine 306 or another component of the system may identify. In some embodiments, for instance, probabilistic black-box anomaly attribution engine 306 (or another component) may determine an anomaly score for each sample in test data 308, which may quantify how anomalous each sample is. An anomaly score may be calculated using any suitable approach.

For example, an anomaly score may be computed as the negative log-likelihood of the test sample(s). From the deterministic regression model, a probability density over the output, given the input signal, can be obtained. Assuming the data points are independently and identically distributed, the anomaly score for a single sample can be expressed as the negative of the natural logarithm of this probability. The following formula may be used, for example, where a is the anomaly score for sample with variables (x^{t}, y^{t}), which is equal to the negative natural logarithm of the conditional probability p of y^{t} given x^{t}:

$$a ( {x}^{{}_{t}} , {y}^{{}_{t}} ) = - ln p ( {y}^{{}_{t}} \vert {x}^{{}_{t}} )$$

As another example, in a collective case where multiple samples are considered, the anomaly score may be calculated by taking the average of the negative natural logarithms of the probabilities of all the samples. This gives a collective anomaly score for the test set. The following formula may be used, for instance, where a is the collective anomaly score for the entire test set Dₛₑₜ. The test dataset consists of Nₜₑₛₜ test samples.

$$a ( {𝒟}_{t e s t} ) = - \frac{1}{{N}_{t e s t}} {\sum }_{t = 1}^{{N}_{t e s t}} ln p ( {y}^{{}_{t}} \vert {x}^{{}_{t}} )$$

In some embodiments, if the score representing how anomalous a sample is crosses a predetermined threshold, it may trigger the next step of attributing the anomaly associated with the anomalous sample to certain variables. The information extracted from the black-box model 302 and the test data 308 may thus be analyzed by the probabilistic black-box anomaly attribution engine 306, which may in turn be configured to identify and/or process the anomaly scores quantifying how anomalous each sample is and the attribution scores attributing these anomalies to the variables.

Attribution score 310 may be generated by the probabilistic black-box anomaly attribution engine 306. This score may represent the distribution of responsibility scores for each variable, providing insights into how each variable contributes to the detected anomalies. This detailed understanding may help in demystifying the operations of the black-box model and may offer information for potential improvements or changes. For example, in a house pricing model, if an anomaly is detected in the price prediction for a certain house listing, the attribution score could highlight which feature of the house (e.g., number of rooms, location, age of the property) was most responsible for the anomaly. This provides a route for more detailed analysis and better understanding of the factors affecting the house pricing.

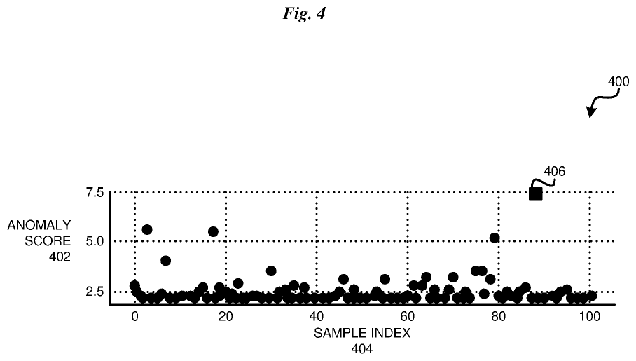

With reference to FIG. 4 this figure depicts a block diagram of example test data 400 in the context of real estate.

Anomaly-score axis 402 may represent the calculated anomaly score for each house sample in the dataset. This score may be a measure of how much the house's features deviate from what the model predicts for its price range. For instance, a higher anomaly score may imply a larger divergence from the expected price given the house's features. This could be indicative of potential bargains or overpriced properties in the market, depending on the direction of the deviation. The anomaly-score axis may thus help in identifying outliers or anomalies in the dataset, enabling more informed decision-making during the real estate valuation process.

Sample-index axis 404 may represent the unique identifier or index for each house sample in the dataset. This axis may function as a reference to navigate through the vast array of houses in the dataset. The index could be sequentially assigned based on the order of entry into the dataset or might be based on a unique property identification provided in the original housing data.

Anomalous sample 406 may represent a particular house sample that has a high anomaly score. This score suggests a significant deviation of this house's features from what would be expected in its price range. For instance, a house may have more rooms and fewer low-income neighbors than what the model predicts for houses in its price bracket. These deviations, which contribute to the high anomaly score, imply that this house could potentially be a valuable bargain, thus warranting further investigation.

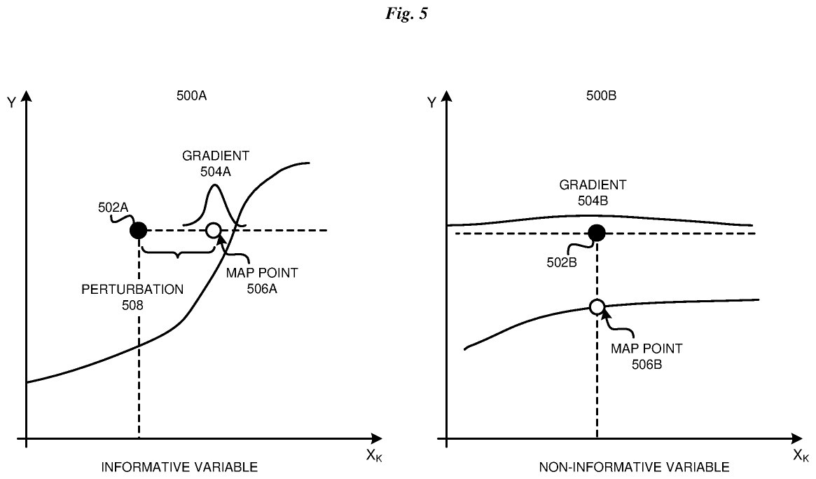

With reference to FIG. 5, this figure depicts a block diagram of an example informative variable 500a and an example non-informative variable 500b. As shown, informative variable 500a and non-informative variable 500b may be represented using gradients 504a and 504b, maximum a posteriori (MAP) points 506a and 506b, and perturbation 508. These components may be used to determine whether a variable is informative with respect to an anomalous sample. An informative variable, in this context, may be one that contributes to the anomalous sample, while a non-informative variable may have a minimal or negligible contribution.

Gradients 504a and 504b may represent the correlation between these variables and the target sample. A steeper gradient for an informative variable may indicate a stronger correlation, thereby confirming its relevance to the prediction task. For instance, in a linear regression model predicting house prices, the square footage of the home might have a steeper gradient (informative variable) compared to the age of the house (non-informative variable).

Maximum a posteriori (MAP) points 506a and 506b may represent an estimate of an unobserved quantity on the basis of the test data. MAP is a method used in Bayesian statistics to estimate an unknown quantity. MAP estimates may be the values that maximize the posterior distribution, given the observed data. For an informative variable, the MAP point might be significantly different from zero, indicating the variable has a strong influence on the target. Conversely, for a non-informative variable, the MAP point may be closer to zero, demonstrating its lesser impact on the target.

Perturbation 508 may represent how much a variable's value would need to change to affect the target. This can be thought of as a “what-if” scenario: what if the value of this variable was different, how would that change the outcome? For an informative variable, slight perturbations could lead to significant changes in the outcome, whereas for non-informative variables, even large perturbations may result in little to no change in the output.

The process of understanding the relationship between variables and a target prediction can be better explained with a real-world example of real estate. Here, a model may be configured to predict the price of a house based on variables such as the number of rooms, the percentage of low-price neighbors, the age of the house, etc. The predictive model may be trained using a machine learning technique, such as random forest, which consists of many individual decision trees operating as an ensemble.

In this model, the gradients 504a and 504b may be representative of how steeply the predicted house price changes with each unit change in the variable. For example, the gradient for the number of rooms might be steep, indicating that adding one more room greatly increases the predicted house price, thus making the number of rooms an informative variable. Conversely, the house age might have a shallow gradient, showing that the price does not change dramatically with the age of the house, thereby classifying this as a non-informative variable.

Maximum a posteriori (MAP) points 506a and 506b may represent the most probable values of the variables that maximize the likelihood of the observed data given the model. This can be thought of as an ideal spot where the variable value aligns most closely with the predicted house price. For instance, the MAP point for low-price neighbors might be low, suggesting that houses in low-price neighborhoods typically have lower prices. If the low-price neighbor for a specific house is drastically different from its MAP point, it may suggest an anomaly and the house price prediction may not be accurate for this outlier.

Perturbation 508 may refer to a change in the variables' values and observing the resultant changes in the predicted output. Suppose we were to make a small increase in the number of rooms for a house (say from 3 rooms to 4). If this leads to a substantial increase in the predicted house price, it confirms the number of rooms as an informative variable. On the other hand, a similar change in a non-informative variable, like the age of the house, might not have a significant impact on the price prediction.

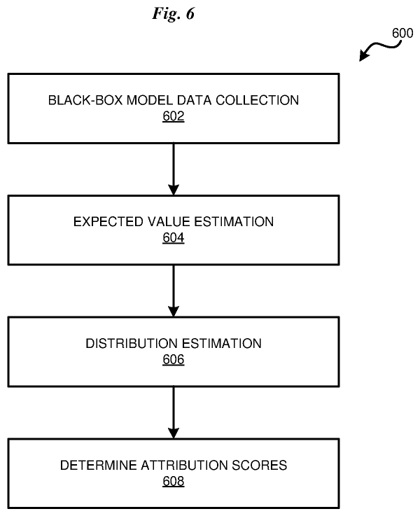

With reference to FIG. 6, this figure depicts a block diagram of an example process for probabilistic black-box anomaly attribution 600. The example block diagram of FIG. 6 may be implemented using probabilistic black-box anomaly attribution engine 200 of FIG. 1.

In the depicted example, at block 602, the process may collect black-box model data. The black-box model may be one in which its internal workings are not known or are purposely kept undisclosed. The data collected from the model can include the model itself, test datasets, constants, distribution models, or any other information pertinent to the black-box model. This step may also involve preprocessing of the data, which can include activities such as cleaning the data, handling missing data, standardization, or normalization, to make it suitable for the subsequent steps in the process.

At block 604, the process may perform expected value estimation. The expected value may refer to the long-run average value of random variables, which may represent the typical or “expected” output from the black-box model given a set of inputs. Determining the expected value can provide insight into how the black-box model generally behaves, and this information may be used for identifying anomalous behavior.

At block 606, the process may perform distribution estimation. This process may entail estimating the probability distribution that a particular set of data or a specific variable follows. The estimated distribution may form the basis for statistical inference, including identifying outliers or anomalies. This step may involve the use of statistical algorithms, such as when dealing with high-dimensional or multivariate data.

At block 608, the process may determine the attribution scores for the model's variables. Attribution scores may be numerical representations that gauge the relative importance of different variables. When a feature or variable exhibits a high attribution score, it may mean that perturbations or changes in that specific feature are likely to result in significant alterations in the model's output. For instance, in a predictive model for house prices, if the location of the house (e.g., proximity to a city center) yields a high attribution score, it may signal that this factor is pivotal in determining the price of the house. Conversely, a low attribution score may suggest that changes in the respective feature have a marginal or negligible impact on the model's outcome.

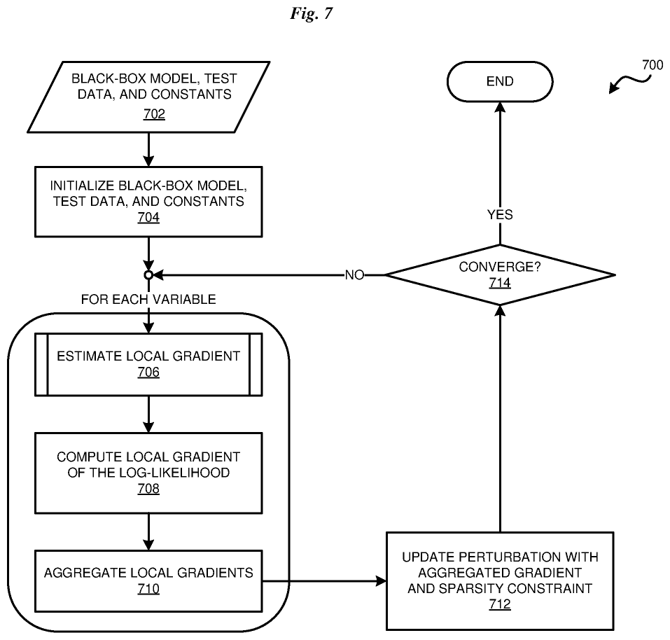

With reference to FIG. 7, this figure depicts a block diagram of an example process for performing expected value estimation 700. The example block diagram of FIG. 7 may be implemented using probabilistic black-box anomaly attribution engine 200 of FIG. 1.

At block 702, the process may receive data associated with the black-box model, including access to the black-box model itself, test data, and constants, or any other necessary data. The black-box model may represent a computational model whose internal workings are not transparent. The test data may provide the means to evaluate the expected value estimations, and it may include one or more anomalous samples. The constants may represent predefined values that remain unchanged throughout the analysis. For example, constants may represent mathematical parameters (e.g., η, ν, κ, a0, {b(x^{t})} as discussed herein), which may depend on the particular equations used to perform the probabilistic black-box anomaly attribution.

At block 704, the process may initialize a perturbation as zero. The perturbation within this context may represent the changes within the system's variables that directly impact its output. By setting the perturbation at zero, the procedure sets a starting point for further analysis.

Subsequently, for each variable, starting with block 706, the process may estimate a local gradient. The local gradient may represent the rate at which a slight change in an variable will impact the output. Here, differentiation techniques may be used to calculate the slope of the output function concerning each variable at a certain point. In some embodiments, for example, the following formula may be used to compute the local gradient (denoted as

$$\frac{\partial f ( {x}_{δ} )}{\partial {δ}_{i}} )$$

of a function f at a perturbed point x_{δ} by taking into account variations introduced by some hidden or latent variable h. The formula provides an approach to compute this gradient both exactly (using integration) and approximately (using finite sampling).

$$\frac{\partial f ( {x}_{δ} )}{\partial {δ}_{i}} = \int d h p ( h \vert {x}_{δ} ) \frac{f ( {x}_{δ} + h {e}_{i} ) - f ( {x}_{δ} )}{h} \approx \frac{1}{{N}_{s}} {\sum }_{n = 1}^{{N}_{s}} \frac{f ( {x}_{δ} + {h}^{[ n ]} {e}_{i} ) - f ( {x}_{δ} )}{{h}^{[ n ]}}$$

At block 708, the process may compute the local gradient for the log-likelihood. The log-likelihood is a concept in statistics that quantifies the fit of a statistical model to a data sample based on given values of unknown parameters. By calculating the gradient of this value, the process can quantify how a minor variation in the variables affects the log-likelihood. This may help understand how different variables influence the final model output. In some embodiments, for example, this step may involve maximizing the log-likelihood to find the optimal parameter values that best fit the data. This may be achieved through iterative optimization techniques, where the local gradient directs the adjustments to the parameters in the direction that increases the log-likelihood. By doing so, the process not only identifies the most probable parameter values given the data but also gains insights into the sensitivity of the model fit to changes in these parameters.

The following formula may be used, for example, which provides an iterative method to estimate gamma hyper-parameters. In the formula, ao represents a hyper-parameter related to the gamma prior, b(x^{t}) is another hyper-parameter related to the gamma prior, but it is location-dependent (i.e., it changes with different values of x^{t}), \tilde{w}ₙ is a weighted term defined as the ratio of wₙ to the sum of all w values, y(n) represents the actual data value at point n, and f(x(n)) represents the model's output at point x(n). The initial estimation of b₀ may be linked to the average squared difference between the observed data and the function's prediction, scaled by the hyper-parameter a₀. Further, a correction factor c_{b} may be used to refine the estimation of b₀ to better match the distribution of the data.

$$\frac{1}{b ( {x}^{{}_{t}} )} ← \frac{2 {a}_{0} + 1}{{a}_{0}} {\sum }_{n \neq t} \frac{{\tilde{w}}_{n} ( {x}^{{}_{t}} )}{2 b ( {x}^{{}_{t}} ) + {[ {y}^{( n )} - f ( {x}^{( n )} ) ]}^{2}}$$

At block 710, the process may aggregate the local gradients. At this step, all the computed local gradients may be combined into a unified representation. This step may help understand the total change in output caused by minor perturbations in all variables.

At block 712, the process may update the perturbation with the aggregated gradient and a sparsity constraint. A sparsity constraint may help ensure that only the essential and relevant variables are included in the final perturbation, simplifying the complexity of the model. This stage may involve an optimization process, seeking the minimum perturbation that can restore the black-box model output to its expected value. This may be akin to a process of elimination, where unnecessary information is disregarded to focus on the important information. In some embodiments, for example, the process may perform regularization to impose constraints on the solution to prevent overfitting. The following equation may be used, for instance, where δ represents a vector of perturbations to the input, η is a scaling factor that weights the l2 regularization, and v is a factor that defines the strength of the l1 regularization relative to l2.

$$p ( δ ) ∝ exp \{ - \frac{η}{2} {‖ δ ‖}_{2}^{2} - η {v ( ‖ δ ‖ )}_{1} \}$$

In some embodiments, updating the perturbation may involve use of the following formula, which updates the perturbation δᵢ by considering the gradient information encapsulated in g and applying l1-based sparsity constraints through a soft thresholding operation. The formula results in a sparse update, meaning many elements of the perturbation δ will be exactly zero.

$${δ}_{i} = sign ( {g}_{i} ) max \{ 0 , \vert {g}_{i} \vert - η v \}$$

At block 714, the process may determine whether there is convergence. Convergence may indicate the point at which subsequent iterations do not significantly impact the perturbation. This may be determined by setting a threshold for the difference between the perturbations from two consecutive iteration, which may be tailored for the particular use or application. If there is no convergence as determined at block 714, the procedure may repeat the analysis for each variable, starting again at block 706. At this stage, it continues to iterate through the process, calculating gradients, aggregating them, and updating the perturbation, until it attains a state of convergence. Finally, if there is convergence, the process may end. Achieving convergence may indicate that the system has reached a stable point where additional iterations will not significantly alter the expected value.

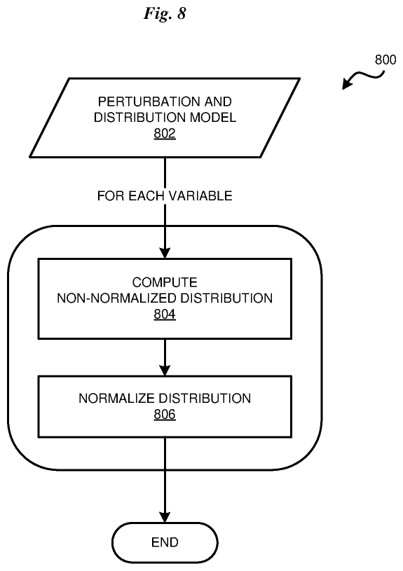

With reference to FIG. 8 this figure depicts a block diagram of an example process for performing distribution estimation 800. The example block diagram of FIG. 8 may be implemented using probabilistic black-box anomaly attribution engine 200 of FIG. 1.

At block 802, the process may receive data associated with the black-box model, which may include a perturbation representing a slight modification or tweak in the model parameters to observe the resulting changes in the output (e.g., as computed using the process described in connection with FIG. 7), a distribution model representing a statistical or mathematical construct that defines the shape or spread of the probable outcomes, or any other required data. In some embodiments, the distribution model might use a formula that calculates the posterior distribution of perturbations. For example, the distribution model may be represented using one of the following formulas. In the equations, Q(δ) represents the posterior distribution, p(δ) is the prior distribution of perturbations, p(y^{t}|xt, δ, λ) is a likelihood function integrated (marginalized) over the λ parameter, f(x^{t}+δ) is the output of the black-box model for a given input, and parameters b₀ and a₀ provide the shape of the distribution.

$$Q ( δ ) ∝ p ( δ ) {\prod }_{t = 1}^{{N}_{t e s t}} {\int }_{0}^{∞} d λ p ( {y}^{{}_{t}} \vert {x}^{{}_{t}} , δ , λ ) p ( λ ) \\ Q ( δ ) ∝ p ( δ ) {\prod }_{t = 1}^{{N}_{t e s t}} \frac{1}{\sqrt{{b}_{0}}} {\{ 1 + \frac{{[ {y}^{{}_{t}} - f ( {x}^{{}_{t}} + δ ) ]}^{2}}{2 {b}_{0}} \}}^{- ( {a}_{0} + \frac{1}{2} )}$$

Next, for each variable, starting with block 804, the process may compute a non-normalized distribution. This step may involve evaluating the raw likelihood based on current model parameters and inputs. An intermediate representation of these likelihoods might be employed using a formula that determines the distribution of perturbation for an individual variable in relation to other variables. In some embodiments, for example, the process may employ the following formula, which can be used to find the posterior qₖ for a specific variable δₖ using distribution model Q by considering all other variables at their MAP estimates (denoted by δᵢ*) and varying only δₖ.

$${q}_{k} ( {δ}_{k} ) ∝ Q ( {δ}_{1}^{*} , … , {δ}_{k - 1}^{*} , {δ}_{k} , {δ}_{k + 1}^{*} , … , {δ}_{M}^{*} )$$

In some embodiments, a MAP point may be estimated using the following formula, which minimizes the discrepancy between model predictions and data while simultaneously penalizing models that have large or numerous non-zero coefficients. In the formula, δ* represents the MAP estimate, J(δ) is a cost or loss function that measures the discrepancy between the predictions of a model and the actual observed data, η is a regularization parameter, and ν is the strength of the l1 regularization relative to that of other potential regularizations or penalties.

$${δ}^{*} = arg {min}_{δ} \{ J ( δ ) + η v {‖ δ ‖}_{1} \}$$

At block 806, the process may normalize the distribution. This operation may involve scaling the raw likelihoods such that the total sum of probabilities across all potential outcomes equals one, conforming to the rules of probability theory. This transformation may allow the model to provide precise, interpretable probabilities for each outcome, which are may be used for data analysis and decision-making. In some embodiments, for example, the process may involve performing numerical integration to compute normalization constants.

Thereafter, the process may end with a finalized distribution. This distribution may represent a quantitative understanding of the underlying data structure and the potential outcomes based on the black-box model inputs. In some embodiments, thresholding or another operation may be performed to identify the most influential variable (or multiple influential variables) resulting in the anomaly.

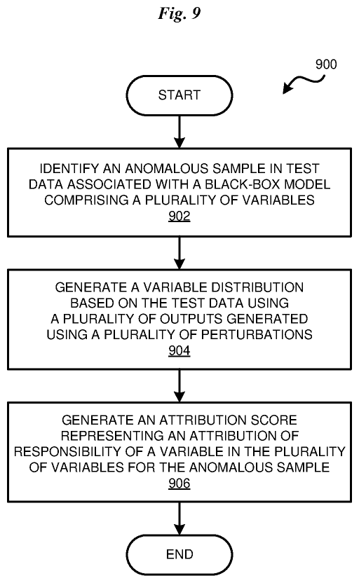

With reference to FIG. 9, this figure depicts a block diagram of an example process for probabilistic black-box anomaly attribution in accordance with an illustrative embodiment 900. The example block diagram of FIG. 9 may be implemented using probabilistic black-box anomaly attribution engine 200 of FIG. 1.

In the illustrative embodiment, at block 902, the process may identify an anomalous sample in test data associated with a black-box model, the black-box model comprising a plurality of variables. At block 904, the process may generate a variable distribution based on the test data using a plurality of outputs generated using a plurality of perturbations. At block 906, the process may generate an attribution score representing a of responsibility of a variable for the anomalous sample. It is to be understood that steps may be skipped, modified, or repeated in the illustrative embodiment. Moreover, the order of the blocks shown is not intended to require the blocks to be performed in the order shown, or any particular order.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
identifying, by a probabilistic black-box anomaly attribution engine, an anomalous sample in test data associated with a black-box model, the black-box model comprising a plurality of variables;
generating, by the probabilistic black-box anomaly attribution engine, a variable distribution based on the test data using a plurality of outputs generated using a plurality of perturbations; and
generating, by the probabilistic black-box anomaly attribution engine based on the variable distribution, an attribution score representing a responsibility of a variable for the anomalous sample.

2. The method of claim 1, further comprising:
performing expected value estimation for each variable in the plurality of variables by using an estimated local gradient and a sparsity constraint.

3. The method of claim 1, where identifying the anomalous sample further comprises:
generating a plurality of anomaly scores by computing a negative natural logarithm of a conditional probability using the test data.

4. The method of claim 3, where identifying the anomalous sample further comprises:
identifying the anomalous sample by applying an anomaly threshold to the plurality of anomaly scores.

5. The method of claim 1, wherein generating the variable distribution further comprises:
determining a variable-wise posterior distribution by performing statistical parameter fitting, the statistical parameter fitting being based on the plurality of outputs generated using the plurality of perturbations.

6. The method of claim 5, further comprising:
utilizing a variational Bayesian inference to determine the variable-wise posterior distribution.

7. The method of claim 5, wherein generating the variable distribution further comprises:
computing a plurality of maximum a posteriori (MAP) points for the plurality of variables.

8. The method of claim 7, wherein generating the variable distribution further comprises:
performing the statistical parameter fitting by estimating the plurality of variables at their MAP points and by varying the plurality of perturbations.

9. The method of claim 1, wherein generating the attribution score further comprises:
assigning a high attribution score for a sharp variable distribution; and
assigning a low attribution score for a flat variable distribution.

10. A computer program product comprising one or more computer readable storage media, and program instructions collectively stored on the one or more computer readable storage media, the program instructions executable by a processor to cause the processor to perform operations comprising:
identifying, by a probabilistic black-box anomaly attribution engine, an anomalous sample in test data associated with a black-box model, the black-box model comprising a plurality of variables;
generating, by the probabilistic black-box anomaly attribution engine, a variable distribution based on the test data using a plurality of outputs generated using a plurality of perturbations; and
generating, by the probabilistic black-box anomaly attribution engine based on the variable distribution, an attribution score representing a responsibility of a variable for the anomalous sample.

11. The computer program product of claim 10, further comprising:
performing expected value estimation for each variable in the plurality of variables by using an estimated local gradient and a sparsity constraint.

12. The computer program product of claim 10, where identifying the anomalous sample further comprises:
generating a plurality of anomaly scores by computing a negative natural logarithm of a conditional probability using the test data.

13. The computer program product of claim 12, where identifying the anomalous sample further comprises:
identifying the anomalous sample by applying an anomaly threshold to the plurality of anomaly scores.

14. The computer program product of claim 10, wherein generating the variable distribution further comprises:
determining a variable-wise posterior distribution by performing statistical parameter fitting, the statistical parameter fitting being based on the plurality of outputs generated using the plurality of perturbations.

15. The computer program product of claim 10, wherein generating the attribution score further comprises:
assigning a high attribution score for a sharp variable distribution; and
assigning a low attribution score for a flat variable distribution.

16. A computer system comprising a processor and one or more computer readable storage media, and program instructions collectively stored on the one or more computer readable storage media, the program instructions executable by the processor to cause the processor to perform operations comprising:
identifying, by a probabilistic black-box anomaly attribution engine, an anomalous sample in test data associated with a black-box model, the black-box model comprising a plurality of variables;
generating, by the probabilistic black-box anomaly attribution engine, a variable distribution based on the test data using a plurality of outputs generated using a plurality of perturbations; and
generating, by the probabilistic black-box anomaly attribution engine based on the variable distribution, an attribution score representing a responsibility of a variable for the anomalous sample.

17. The computer system of claim 16, further comprising:
performing expected value estimation for each variable in the plurality of variables by using an estimated local gradient and a sparsity constraint.

18. The computer system of claim 16, where identifying the anomalous sample further comprises:
generating a plurality of anomaly scores by computing a negative natural logarithm of a conditional probability using the test data; and
identifying the anomalous sample by applying an anomaly threshold to the plurality of anomaly scores.

19. The computer system of claim 16, wherein generating the variable distribution further comprises:
determining a variable-wise posterior distribution by performing statistical parameter fitting, the statistical parameter fitting being based on the plurality of outputs generated using the plurality of perturbations.

20. The computer system of claim 16, wherein generating the attribution score further comprises:
assigning a high attribution score for a sharp variable distribution; and
assigning a low attribution score for a flat variable distribution.
